(19) United States
(12) Patent Application Publication
(10) Pub. No.: US 2013/0162591 A1
(43) Pub. Date: Jun. 27, 2013

(54) PORTABLE TERMINAL DEVICE

(71) Applicant: FUJITSU LIMITED, Kawasaki (JP)

(72) Inventors: Hiroshi HIDAKA, Kawasaki (JP); Yuichi Murase, Yokohama (JP)

(73) Assignee: FUJITSU LIMITED, Kawasaki (JP)

(21) Appl. No.: 13/655,619

(22) Filed: Oct. 19, 2012

(30) Foreign Application Priority Data
Dec. 21, 2011 (JP) 2011-280529

(51) Int. Cl. G06F 3/041

(52) U.S. Cl. 345/174

(57) ABSTRACT

A portable terminal device includes an operation panel that displays an input region and detects a contact position, an actuator fixed to the operation panel to vibrate the operation panel when the contact position detected by the operation panel is included in the input region, a housing accommodating the operation panel and having an opening through which the operation panel is exposed, and a member provided in the box to support the operation panel with the operation panel pressed toward the housing so as to bring the operation panel into contact with and away from the housing, the member having a vibration absorbing property higher than a vibration absorbing property of the housing.

### CROSS-REFERENCE TO RELATED APPLICATION

This application is based upon and claims the benefit of priority of the prior Japanese Patent Application No. 2011-280529, filed on Dec. 21, 2011, the entire contents of which are incorporated herein by reference.

### FIELD

The embodiments discussed herein are related to a portable terminal device such as a smartphone.

### BACKGROUND

A portable terminal device such as a smartphone has an operation panel to be operated by a user, a box as a housing for accommodating the operation panel. Since the operation panel is a so-called touch-type input device, it is difficult to feel the reality of input (hereinafter referred to as the feeling of input), compared to a so-called button-type input device.

To address this problem, a portable terminal device that vibrates the operation panel upon detection of a contact of a fingertip has been suggested so as to provide the feeling of input from the fingertip in contact with the operation panel. An example of the portable terminal device that vibrates the operation panel is disclosed in which an actuator that vibrates the box when an incoming call arrives is also in contact with the operation panel to vibrate both of the operation panel and the box when the operation panel is operated. Another portable terminal device is also disclosed in which an actuator is mounted on each of the operation panel and the box to individually vibrate the operation panel and the box.

However, when the box vibrates when the operation panel is operated, vibrations are transmitted to the palm that is holding the box, thereby making the user feel strange. Moreover, if an actuator is mounted on each of the operation panel and the box, this causes an increase in cost of the portable terminal device.

Japanese Laid-open Patent Publication No. 2002-149312 is an example of related art.

### SUMMARY

According to an aspect of the invention, a portable terminal device includes an operation panel that displays an input region and detects a contact position, an actuator fixed to the operation panel to vibrate the operation panel when the contact position detected by the operation panel is included in the input region, a housing accommodating the operation panel and having an opening through which the operation panel is exposed, and a member provided in the box to support the operation panel with the operation panel pressed toward the housing so as to bring the operation panel into contact with and away from the housing, the member having a vibration absorbing property higher than a vibration absorbing property of the housing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view of a smartphone according to a first embodiment;

FIG. 2 is an exploded perspective view of the smartphone according to the first embodiment;

FIG. 3 is a sectional view of the smartphone according to the first embodiment;

FIG. 4 is a partially sectional view of the smartphone according to the first embodiment;

FIG. 5 is a schematic view of functional blocks of the processor according to the first embodiment;

FIG. 6 is a flowchart of a process by the processor according to the first embodiment;

FIG. 7A and FIG. 7B are schematic views of the smartphone when a fingertip is in contact with an operation panel according to the first embodiment;

FIG. 8A and FIG. 8B are schematic views of the smartphone when a fingertip is not in contact with the operation panel according to the first embodiment;

FIG. 9 is a partially sectional view of a smartphone according to a modification example of the first embodiment;

FIG. 10 is a sectional view of a smartphone according to a second embodiment;

FIG. 11 is a partially sectional view of the smartphone according to the second embodiment;

FIG. 12 is a schematic diagram of functional blocks of a processor according to the second embodiment;

FIG. 13 is a flowchart of a process by the processor according to the second embodiment;

FIG. 14 is a schematic view of the smartphone when a fingertip is in contact with an operation panel according to the second embodiment;

FIG. 15 is a sectional view of a smartphone according to a third embodiment;

FIG. 16 is a schematic view of the smartphone when a fingertip is in contact with an operation panel according to the third embodiment;

FIG. 17 is a plan view of a smartphone with a cover being removed therefrom according to a fourth embodiment;

FIG. 18 is a sectional view of the smartphone according to the fourth embodiment;

FIG. 19 is a schematic diagram of the smartphone when a fingertip is in contact with an operation panel according to the fourth embodiment;

FIG. 20A and FIG. 20B are schematic diagrams for describing first experiment results of transmission of vibrations by an experiment model;

FIG. 21A and FIG. 21B are schematic diagrams for describing second experiment results of transmission of vibrations by the experiment model; and

FIG. 22A and FIG. 22B are schematic diagrams for describing third experiment results of transmission of vibrations by the experiment model.

### DESCRIPTION OF EMBODIMENTS

### First Embodiment

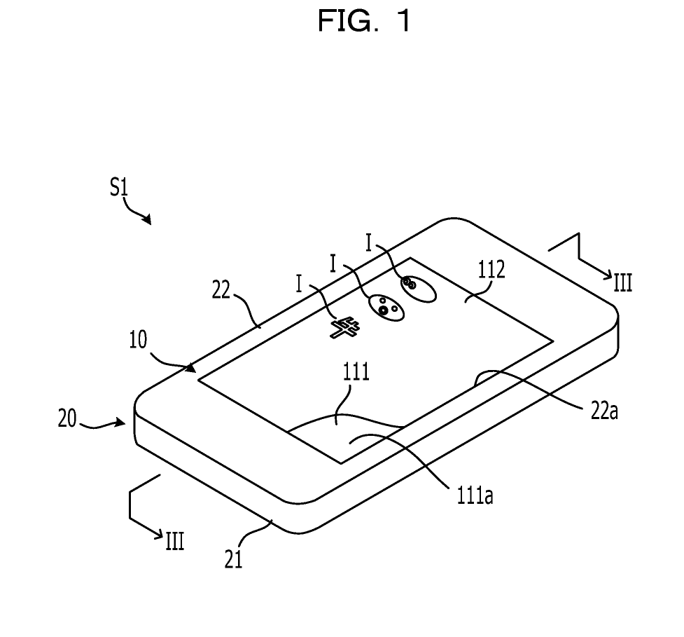

With reference to FIG. 1 to FIG. 8B, a first embodiment is described below.

(General Outline of Smartphone S1)

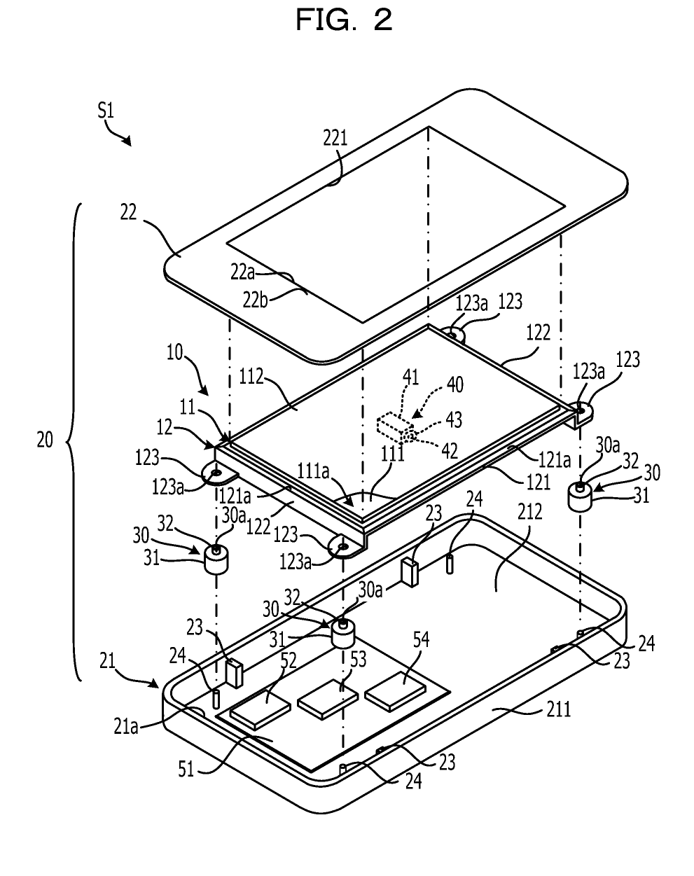

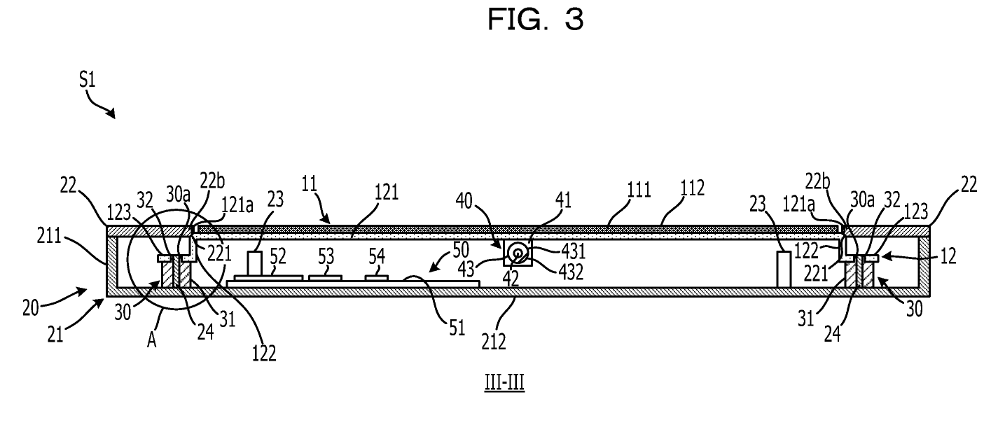

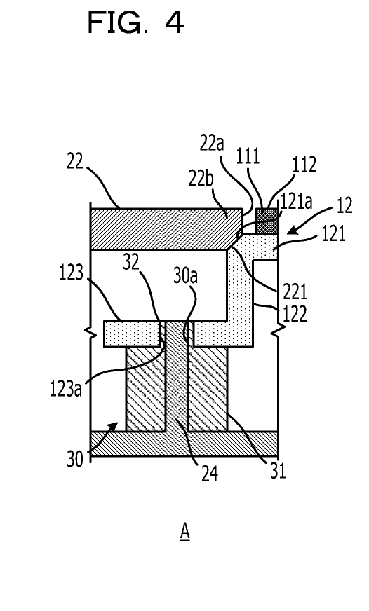

FIG. 1 is a perspective view of a smartphone S1 according to the first embodiment. FIG. 2 is an exploded perspective view of the smartphone S1 according to the first embodiment. FIG. 3 is a sectional view of the smartphone S1 according to the first embodiment, depicting a section along a III-III line in FIG. 1. FIG. 4 is a partially sectional view of the smartphone S1 according to the first embodiment, depicting the inside of a circular frame A in FIG. 3.

As depicted in FIG. 1 to FIG. 4, the smartphone S1 according to the present embodiment includes an operation unit 10, a box 20 as a housing, cushioning members (vibration absorbing members) 30, an eccentric motor (an actuator) 40, and a substrate unit 50. Note that while the smartphone S1 is described in the present embodiment, the smartphone S1 is not restrictive and any portable terminal device may be used as long as the device has mounted thereon a touch sensor 112, which will be described further below.

(Operation Unit 10)

The operation unit 10 is placed inside the box 20. The operation unit 10 includes an operation panel 11 to be operated by the user and a bracket 12 that holds the operation panel 11.

The operation panel 11 includes a display device 111 as a display that displays various information and the touch sensor 112 affixed to a display screen 111a of the display device 111. The type of the display device 111 is not particularly restrictive and, for example, a flat display panel such as a liquid-crystal display panel may be used. The touch sensor 112 is also called a touch screen, detecting coordination information of a fingertip F of a user or a contact position of a touch pen, for example. The coordination information detected by the touch sensor 112 is output to a processor 52 as a controller, which will be described further below. The touch sensor 112 is exposed from an opening 22a formed on a cover 22, which will be described further below. Thus, the user may operate the touch sensor 112 from the opening 22a of the cover 22.

The bracket 12 includes a mount plate 121 that has the operation panel 11 mounted thereon, a support plate 122 that supports the mount plate 121, and mount pieces 123 for mounting the operation unit 10 on the box 20.

The mount plate 121 is formed in the same shape as that of the operation panel 11, that is, a rectangular shape, and has a vibration transmitting part 121a formed at a position corresponding to a vibration transmitting part 221 formed on the cover 22. The vibration transmitting part 121a transmits vibrations of the operation unit 10 to the cover 22 of the box 20. The vibration transmitting part 121a is placed around the operation panel 11, and is inclined so as to be away from a bottom plate 212 of a box body 21 as coming closer to the center of the opening 22a of the cover 22. Note that while a tilt angle of the vibration transmitting part 121a is not particularly restrictive, the vibration transmitting part 121a according to the present embodiment is inclined at a tilt angle of approximately 45 degrees with reference to the surface of the bottom plate 212 of the box body 21.

The support plate 122 is coupled to each short side of the mount plate 121, and supports the mount plate 121 in parallel with the bottom plate 212 of the box body 21. Thus, the operation panel 11 mounted on the mount plate 212 is similarly supported in parallel with the bottom plate 212 of the box body 21.

The mount pieces 123 are placed at lower ends of the support plate 122 at predetermined spacing. At the center of each mount piece 123, an insertion hole 123a is formed. The insertion hole 123a has an inner diameter equal to an outer diameter of a small diameter part 32 of each cushioning member 30. The mount pieces 123 are each mounted on a major diameter part 31 of the cushioning member 30. In the insertion hole 123a of each mount piece 123, a guide pin 24 of the box body 21 and the small diameter part 32 of the cushioning member 30 are inserted.

(Box 20)

The box 20 includes the box body 21 that accommodates the operation unit 10, the cover 22 that closes a front opening 21a of the box body 21, stoppers 23 that regulate sinking of the operation unit 10, and the guide pins 24 that guide the operation unit 10.

The box body 21 includes a frame plate 211 as a side wall of the smartphone S1 and a bottom plate 212 as a bottom wall of the smartphone S1, and regulates, with the cover 22, an accommodation space for accommodating the operation unit 10.

The cover 22 is coupled to the box body 21, and has the opening 22a formed at a position facing the display screen 111a of the display device 111. The opening 22a has the same shape as that of the display screen 111a, that is, a rectangular shape. Thus, the touch sensor 112 of the operation panel 11 is exposed from the opening 22a of the cover 22.

An edge 22b of the cover 22 that defines the opening 22a has a vibration transmitting part 221 formed at a position facing the vibration transmitting part 121a of the operation unit 10. The vibration transmitting part 221 is to transmit vibrations of the operation unit 10 to the cover 22. The vibration transmitting part 221 is inclined so as to be away from the bottom plate 212 of the box body 21 as coming closer to the center of the opening 22a of the cover 22. That is, the vibration transmitting part 221 undergoes displacement to a side opposite to the operation panel 11 as coming closer to a center of the opening 22a of the cover 22. The vibration transmitting part 221 has a tilt angle corresponding to the tilt angle of the vibration transmitting part 121a of the operation unit 10. Thus, when the operation unit 10 is placed at a reference position (which will be described further below), the vibration transmitting part 121a of the operation unit 10 and the vibration transmitting part 221 of the cover 22 are in a surface contact with each other, and therefore vibrations of the operation unit 10 are efficiently transmitted to the cover 22.

The stoppers 23 are placed at positions corresponding to four corners of the operation panel 11, and each face a surface of the mount plate 121 having the operation panel 11 mounted thereon on a side opposite to the touch sensor 112, that is, a back surface of the mount plate 121. The stoppers 23 each have a height lower than the back surface of the mount plate 121 when the operation unit 10 is placed at the reference position (which will be described further below) with reference to the bottom plate 212 of the box body 21. Thus, when the operation unit 10 is placed at the reference position (which will be described further below), a clearance is present between the stoppers 23 and the mount plate 121. Although the number of the stoppers 23 and their positions are not particularly restrictive, at least one stopper 23 is preferably placed at a position corresponding to any of four corners of the operation panel 11.

The guide pins 24 are each placed at positions corresponding to the mount pieces 123 of the operation unit 10. The guide pins 24 extend upward from the bottom plate 212 of the box body 21, and are each inserted in the insertion hole 123a formed in each mount piece 123, together with the small diameter part 32 of the cushioning member 30. The guide pins 24 have a height equal to or higher than the surface of the mount pieces 123 when the operation unit 10 is placed at the reference position (which will be described further below) with reference to the bottom plate 212 of the box body 21. Thus, when the operation unit 10 is placed at the reference position (which will be described further below), each guide pin 24 is inserted into the insertion hole 123a of the mount piece 123. The guide pins 24 each have a sectional shape, which is not particularly restrictive but is the same as the sectional shape of the insertion hole 30a of the cushioning member 30, that is, a columnar shape, in the present embodiment. The guide pin 24 has an outer diameter smaller than the inner diameter of the insertion hole 123a of the mount piece 123 by the thickness of the small diameter part 32 of the cushioning member 30, that is, by 0.5 mm to 1.0 mm.

(Cushioning Members 30)

The cushioning members 30 are each placed at positions corresponding to the mount pieces 123 of the operation unit 10. Each of the cushioning members 30 includes the major diameter part 31 to be placed on the bottom plate 212 of the box body 21 and the small diameter part 32 to be inserted into the insertion hole 123a of each mount piece 123. At the center of each cushioning member 30, the insertion hole 30a is formed. The insertion hole 30a penetrates through the major diameter part 31 and the small diameter part 32. In the insertion hole 30a, the guide pin 24 of the box 20 is movably inserted. The small diameter part 32 has an outer diameter equal to the inner diameter of the insertion hole 123a of the mount piece 123. The material of the cushioning members 30 is not particularly restrictive and, for example, a material having a vibration absorbing property higher than that of the material of the box 20 is used, such as low-resilient urethane foam or gel. An example of gel may be an alpha gel made by taica. Thus, the operation unit 10 is movably supported in a direction orthogonal to the display screen 111a of the display device 111. That is, the operation unit 10 is movably supported in the direction orthogonal to the display screen 111a between the “reference position” where the vibration transmitting part 121a of the operation unit 10 is in contact with the vibration transmitting part 221 of the cover 22 and a “regulating position” where the mount plate 121 of the operation unit 10 is in contact with the stoppers 23.

(Eccentric Motor 40)

The eccentric motor 40 is placed on a surface of the mount plate 121 of the operation unit 10 facing to the bottom plate 212 of the box 20, that is, the back surface of the mount plate 121. The eccentric motor 40 includes a motor body 41, a motor shaft 42, and an eccentric plate 43.

The motor body 41 is formed in the shape of a rectangular parallelepiped, and is fixed to an approximately center of the back surface of the mount plate 121 of the operation unit 10. The motor body 41 is fixed by, for example, being adhered with an adhesive or being screwed.

The motor shaft 42 extends in parallel with the mount plate 121 of the operation unit 10, and the eccentric plate 43 is fixed at an end of the motor shaft 42. Thus, when the eccentric motor 40 is activated to rotate the motor shaft 42, the eccentric plate 43 also rotates.

The eccentric plate 43 includes a resin part 431 in the shape of, for example, a disc, and a cone 432 placed at a position deviated from the center axis of the motor shaft 42. The cone 432 has a specific gravity larger than that of the resin part 431. Thus, when the eccentric motor 40 is activated to rotate the eccentric plate 43, the eccentric motor 40 vibrates in a plane crossing the center axis of the motor shaft 42. The eccentric motor 40 has a vibration cycle, which depends on the number of revolutions of the motor shaft 42 of the eccentric motor 40. The vibrations of the eccentric motor 40 are transmitted also to the operation unit 10.

(Substrate Unit 50)

The substrate unit 50 is placed inside the box 20. The substrate unit 50 includes a circuit board 51, a processor 52, a memory 53, and a flash memory 54.

The circuit board 51 is fixed to the bottom plate 212 of the box 20, and the circuit board 51 has a mount surface where the processor 52, the memory 53, the flash memory 54, and other electronic components are mounted.

The processor 52 reads various programs stored in the flash memory 54 for development onto the memory 53 and executes various programs developed on the memory 53, thereby executing various functions. Details of various functions will be described further below.

In the memory 53, various programs read by the processor 52 from the flash memory 54 are stored. The flash memory 54 has stored various programs for controlling the operation of the smartphone 51. A vibration presenting program according to the present embodiment is also stored in the flash memory 54. Note that while the flash memory 54 is used in the present embodiment, this is not restrictive and any memory may be used as long as it is a non-volatile memory.

The processor 52, the memory 53, the flash memory 54, the eccentric motor 40, and the touch sensor 112 are mutually connected to each other via, for example, a bus (not depicted), thereby configuring hardware of the smartphone 51.

(Functional Blocks of the Processor 52)

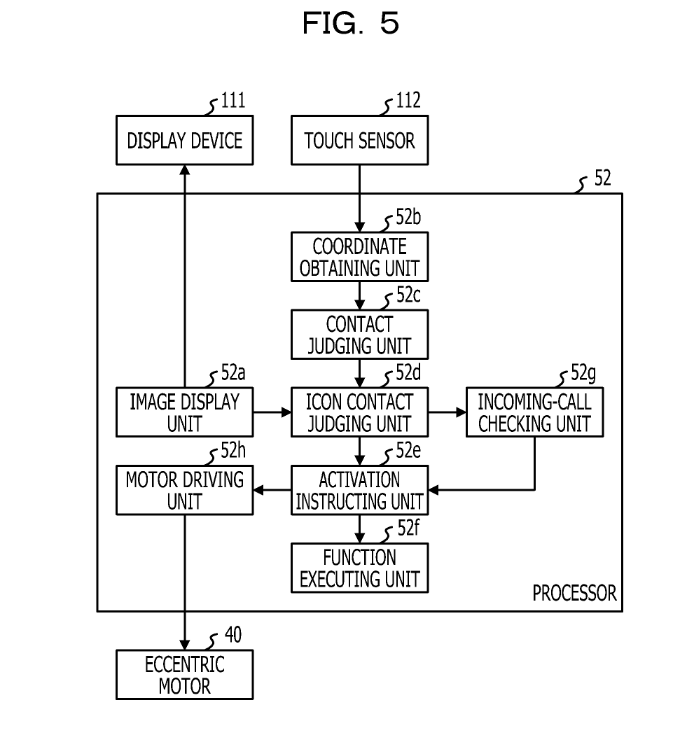

FIG. 5 is a schematic view of functional blocks of the processor 52 according to the first embodiment.

As depicted in FIG. 5, the processor 52 according to the present embodiment includes an image display unit 52a, a coordinate obtaining unit 52b, a contact judging unit 52c, an icon contact judging unit (a first judging unit) 52d, an activation instructing unit 52e, a function executing unit 52f, an incoming-call checking unit 52g, and a motor driving unit 52h.

The image display unit 52a, the coordinate obtaining unit 52b, the contact judging unit 52c, the icon contact judging unit 52d, the activation instructing unit 52e, the function executing unit 52f, the incoming-call checking unit 52g, and the motor driving unit 52h are implemented by the processor 52 based on a vibration presenting program developed on the memory 53.

The image display unit 52a outputs image data to the display device 111 to cause, for example, an image (a standby image) including icons I to be displayed on the display screen 111a.

The coordinate obtaining unit 52b obtains coordinate information of a contact position of the touch sensor 112 based on an output from the touch sensor 112.

The contact judging unit 52c judges whether a contact with the touch sensor 112 is present based on the coordinate information obtained by the coordinate obtaining unit 52b.

The icon contact judging unit 52d judges whether the contact position is in a display region (an input region) of any icon I based on image data obtained from the image display unit 52a and the coordinate information obtained by the coordinate obtaining unit 52b.

When it is judged by the icon contact judging unit 52d that the contact position is in the display region of any icon I, the activation instructing unit 52e instructs the motor driving unit 52h to activate the eccentric motor 40. The activation instructing unit 52e instructs the motor driving unit 52h to activate the eccentric motor 40 when it is judged by the incoming-call checking unit 52g that an incoming call has arrived even if it is not judged by the icon contact judging unit 52d that the contact position is in the display region of any icon I.

When it is judged by the icon contact judging unit 52d that the contact position is in the display region of any icon I, the function executing unit 52f executes a function assigned to the icon I.

When it is not judged by the icon contact judging unit 52d that the contact position is in the display region of any icon I, the incoming-call checking unit 52g checks to see whether an incoming call has arrived.

The motor driving unit 52h activates the eccentric motor 40 based on an instruction from the actuation instructing unit 52e.

(Process Flow by the Processor 52)

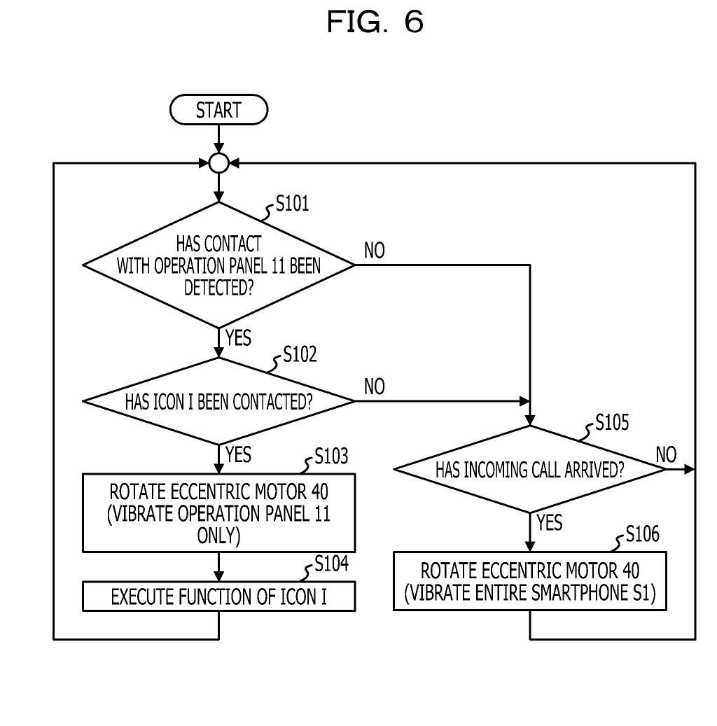

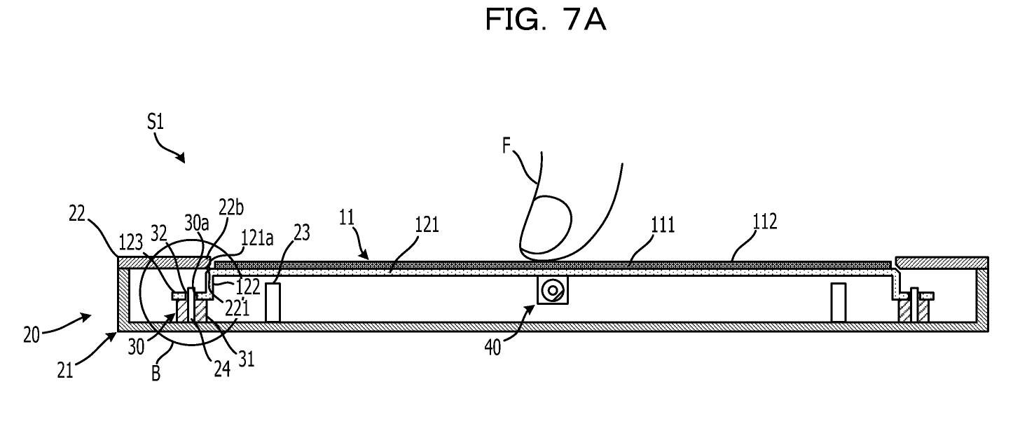

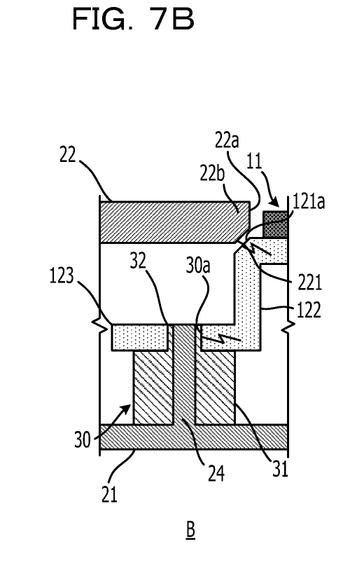

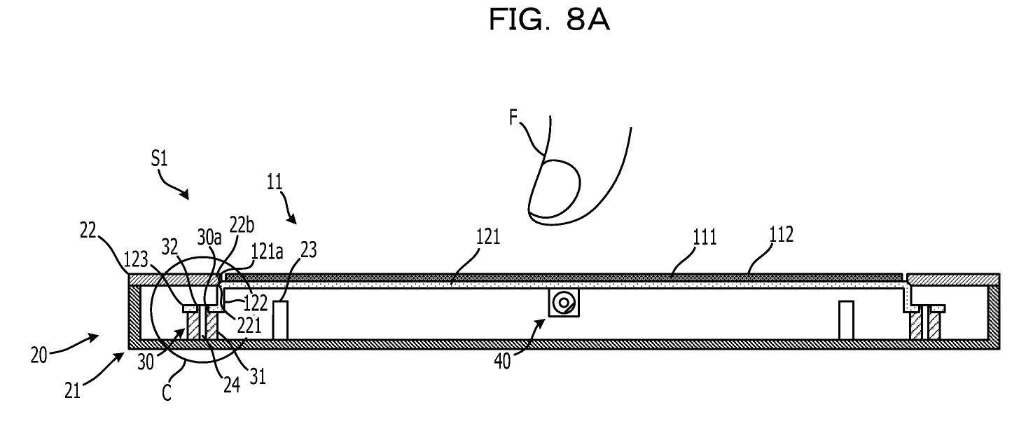

FIG. 6 is a flowchart of a process by the processor 52 according to the first embodiment. FIG. 7A and FIG. 7B are schematic views of the smartphone S1 when a fingertip F is in contact with the operation panel 11 according to the first embodiment. FIG. 7A depicts a section of the entire smartphone S1, and FIG. 7B depicts a section of the inside of a circular frame B of FIG. 7A. FIG. 8A and FIG. 8B are schematic views of the smartphone S1 when a fingertip F is not in contact with the operation panel 11 according to the first embodiment. FIG. 8A depicts a section of the entire smartphone S1, and FIG. 8B depicts a section of the inside of a circular frame C of FIG. 8A.

The process flow according to the present embodiment starts with the vibration presenting program is started by the processor 52. However, it is assumed in the process flow according to the present embodiment that the image display unit 52a causes an image (a standby image) containing the icons I to be displayed on the display screen 111a of the display device 111.

As depicted in FIG. 6, when the process flow starts, the contact judging unit 52c judges whether a contact with the operation panel 11 is present based on the coordination information obtained by the coordinate obtaining unit 52b from the touch sensor 112 (step S101).

When it is judged that a contact with the operation panel 11 is present (Yes at step S101), the icon contact judging unit 52d judges whether the contact position of the touch sensor 112 is in the display region of any icon I based on the image data obtained from the image display unit 52a and the coordinate information obtained from the coordinate obtaining unit 52b (step S102). For example, based on the image data obtained from the image display unit 52a, a coordinate range of the display region of the icon I is extracted, and it is judged whether the contact position of the touch sensor 112 is included in the coordinate range of the display region of the icon I.

When it is judged that the contact position of the touch sensor 112 is in the display region of any icon I (Yes at step S102), the activation instructing unit 52e instructs the motor driving unit 52h to activate the eccentric motor 40. Based on the instruction from the activation instructing unit 52e, the motor driving unit 52h activates the eccentric motor 40 to rotate the motor shaft 42 of the eccentric motor 40 (step S103).

Here, as depicted in FIG. 7A, the operation panel 11 is pressed by the finger tip F of the user. Thus, the operation panel 11 slightly sinks by the pressure of the fingertip F, and a slight clearance occurs between the vibration transmitting part 121a of the operation unit 10 and the vibration transmitting part 221 of the cover 22. Therefore, even if the eccentric motor 40 is activated, vibrations of the operation panel 11 are not transmitted to the cover 22. Also, since the operation panel 11 is supported by the cushioning member 30, vibrations of the operation panel 11 are not transmitted either, from the mount pieces 123 to the bottom plate 212 of the box body 21. With this, while vibrations (the feeling of operation) are transmitted to the fingertip F when the fingertip F is in contact with any icon I on the operation panel 11, vibrations are not transmitted to the palm holding the smartphone S1 (the palm does not feel strange).

Next, the function executing unit 52f executes a function assigned to each icon I (step S104). Therefore, when the fingertip F is in contact with the display region of any icon I on the operation panel 11, the operation panel 11 vibrates, and the function assigned to the icon I is executed. With this the user may feel the reality of operating the operation panel 11, that is, may obtain the feeling of operation (the feeling of input).

Note that the function of the icon I is executed by the function executing unit 52f after the activation instructing unit 52e instructs the motor driving unit 52h to drive the eccentric motor 40 in the present embodiment. However, the present embodiment is not restricted to this. For example, the activation instructing unit 52e may instruct the motor driving unit 52h to drive the eccentric motor 40 at the same time when the function executing unit 52f starts executing the function of the icon I or after the function executing unit 52f starts executing the function of the icon I.

When the function of the icon I is started to be executed, the contact judging unit 52c again judges whether a contact with the operation panel 11 is present based on the coordinate information obtained by the coordinate obtaining unit 52b from the touch sensor 112 (step S101).

On the other hand, if it is not judged that a contact with the operation panel 11 has been detected (No at step S101) or if it is not judged that the contact position of the touch sensor 112 is in the display region of the icon I (No at step S102), the incoming-call checking unit 52g judges whether an incoming call has arrived at the smartphone S1 (step S105).

If it is judged that an incoming call has arrived at the smartphone S1 (Yes at step S105), the activation instructing unit 52e instructs the motor driving unit 52h to activate the eccentric motor 40. Based on the instruction from the activation instructing unit 52e, the motor driving unit 52h activates the eccentric motor 40 to rotate the motor shaft 42 of the eccentric motor 40 (step S106).

Here, as depicted in FIG. 8A, the operation panel 11 is not pressed by the fingertip F of the user. Thus, the operation panel 11 has not sunk, and therefore the surface contact between the vibration transmitting part 121a of the operation unit 10 and the vibration transmitting part 221 of the cover 22 is maintained. Therefore, the vibrations of the operation panel 11 are transmitted from the vibration transmitting part 221 of the cover 22 to the entire box 20. With this, for example, when an incoming call arrives at the smartphone S1, both of the operation panel 11 and the box 20 vibrate, thereby reliably letting the user know the incoming call.

On the other hand, if it is not judged that an incoming call has arrived at the smartphone S1 (No at step S105), the contact judging unit 52c again judges whether a contact with the operation panel 11 is present based on the coordinate information obtained by the coordinate obtaining unit 52b from the touch sensor 112 (step S101).

### Modification Example

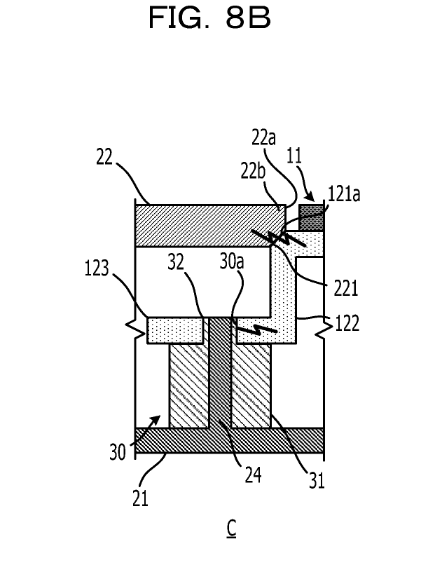

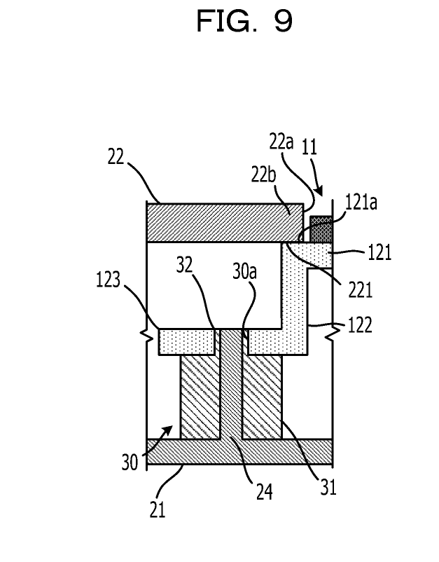

With reference to FIG. 9, a modification example of the first embodiment is described below. Note that structures and processes equivalent to those of the first embodiment are not descried herein.

The modification example of the first embodiment is different from the first embodiment in that both of the vibration transmitting part 221 of the cover 22 and the vibration transmitting part 121a of the operation unit 10 extend in parallel with the operation panel 11.

FIG. 9 is a partially sectional view of a smartphone S1 according to the modification example of the first embodiment.

As depicted in FIG. 9, the edge 22b defining the opening 22a of the cover 22 includes the vibration transmitting part 221 formed at the position facing the mount plate 121 of the operation unit 10 and extending in parallel with the operation panel 11. Also, the mount plate 121 includes the vibration transmitting part 121a formed at the position facing the cover 22 and extending in parallel with the bottom plate 212 of the box body 21.

According to the modification example, the shape of the bracket 12 of the operation unit 10 and the shape of the cover 22 of the box 20 are simplified, and manufacture of the bracket 12 and the cover 22 may be simplified. Also, when the operation panel 11 is operated, the operation panel 11 is pressed in a direction orthogonal to the vibration transmitting part 221 of the cover 22 and the vibration transmitting part 121a of the operation unit 10. Thus, a clearance equivalent to the amount of pressing the operation panel 11 is formed between the vibration transmitting part 221 of the cover 22 and the vibration transmitting part 121a of the operation unit 10. Therefore, when the operation panel 11 is pressed, the vibration transmitting part 221 of the cover 22 and the vibration transmitting part 121a of the operation unit 10 may be reliably separated from each other. With this, when only the operation panel 11 is desired to be vibrated, it is possible to reliably suppress the vibrations of the operation panel 11 being involuntarily transmitted to the box 20. The modification example may be applied to second to fourth embodiments below.

### Second Embodiment

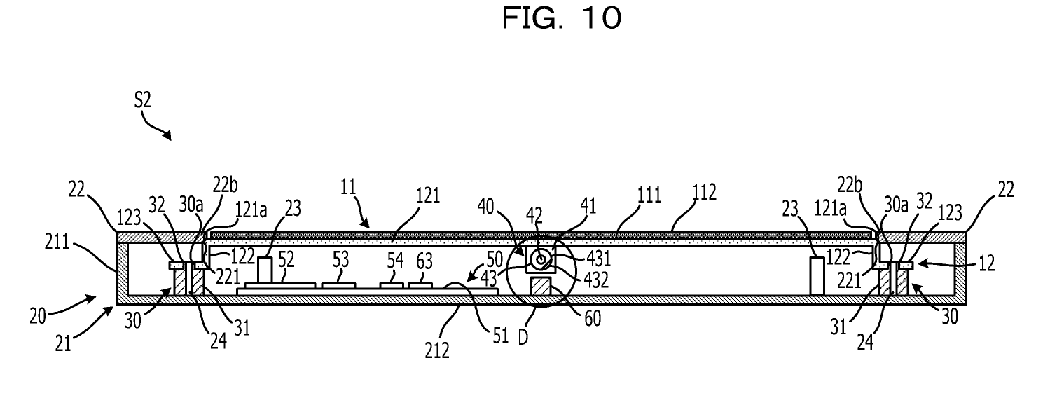

With reference to FIG. 10 to FIG. 14, a second embodiment is described below. Note that structures and processes equivalent to those in the first embodiment are not described herein.

The smartphone S2 according to the second embodiment is different from the first embodiment in that, in place of vibrating the operation panel 11 simply when a contact position on the touch sensor 112 is included in a display region of any icon I, the operation panel 11 is vibrated when the sinking amount of the operation panel 11 reaches a predetermined amount.

FIG. 10 is a sectional view of the smartphone S2 according to the second embodiment. FIG. 11 is a partially sectional view of the smartphone S2 according to the second embodiment, depicting the inside of a circular frame D in FIG. 10.

As depicted in FIG. 10 and FIG. 11, the smartphone S2 according to the present embodiment further includes a cushioning member (a vibration absorbing member) 60 and a push sensor (a detecting unit) 61.

The cushioning member 60 is fixed to a position of the bottom plate 212 of the box body 21 corresponding to the eccentric motor 40. The cushioning member 60 has a height lower than that of the back surface of the motor body 41 of the eccentric motor 40 when the operation unit 10 is placed at the reference position with reference to the bottom plate 212 of the box body 21 by a predetermined amount, approximately 0.5 mm in the present embodiment. Thus, when the operation unit 10 is placed at the reference position, a clearance determined in advance, that is, a clearance of 0.5 mm, is present between the eccentric motor 40 and the cushioning member 60. Also, the cushioning member 60 has a height higher than that of the back surface of the motor body 41 of the eccentric motor 40 when the operation unit 10 is placed at the regulating position with reference to the bottom plate 212 of the box body 21. Thus, when the operation unit 10 is placed at the regulating position or a position lower than the regulating position, the cushioning member 60 is pressed by the eccentric motor 40. The material of the cushioning member 60 is not particularly restrictive and, for example, a material equivalent to that of the cushioning member 30 may be used.

The press sensor 61 is provided to judge whether the press amount of the operation unit 10 has reached a predetermined amount, and includes a mechanical switch 62 and a decision circuit 63.

The mechanical switch 62 includes a first point of contact 62a as a first contact member and a second point of contact 62b as a second contact member. The first point of contact 62a is placed on a surface of the cushioning member 60 facing the motor body 41 of the eccentric motor 40. The second point of contact 62b is placed on a surface of the motor body 41 of the eccentric motor 40 facing the cushioning member 60. Thus, when the operation unit 10 is pressed by the press amount determined in advance, the first point of contact 62a and the second point of contact 62b are in contact with each other. The material of the first point of contact 62a and the second point of contact 62b is not particularly restrictive and, for example, a conductive metal such as Cu may be used.

The decision circuit 63 is mounted on the mount surface of the circuit board 51, and is electrically connected to the first point of contact 62a and the second point of contact 62b. Based on a current value between the first point of contact 62a and the second point of contact 62b, the decision circuit 63 notifies the processor 52 of energization information indicating that a current is flowing between the first point of contact 62a and the second point of contact 62b. Therefore, based on the energization information notified from the decision circuit 63, the processor 52 may judge whether the first point of contact 62a and the second point of contact 62b are in contact with each other, that is, whether the operation panel 11 has been pressed by the press amount determined in advance.

(Functional Blocks of the Processor 52)

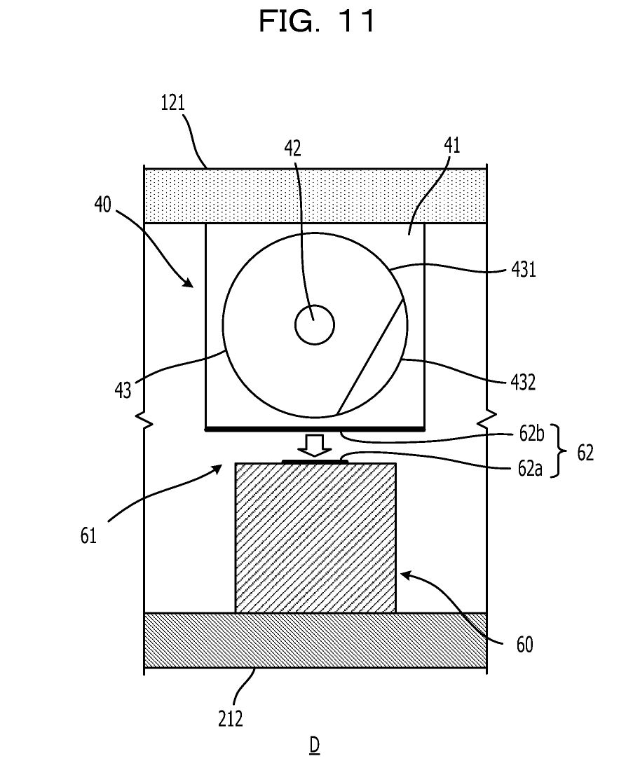

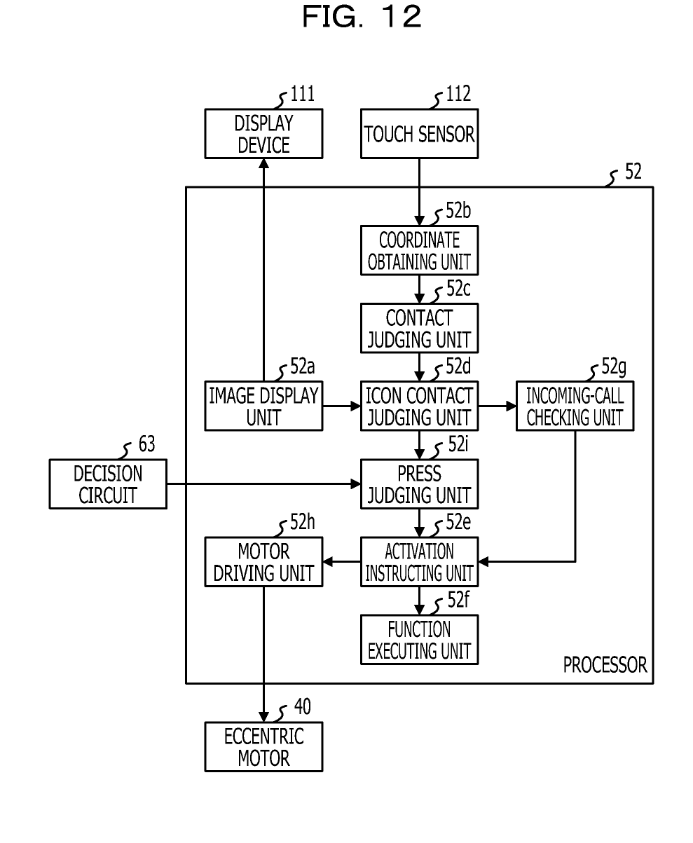

FIG. 12 is a schematic diagram of functional blocks of the processor 52 according to the second embodiment.

As depicted in FIG. 12, the processor 52 according to the present embodiment further includes a press judging unit (a second judging unit) 52i. The press judging unit 52i is implemented by the processor 52 based on the vibration presenting program developed on the memory 53.

The press judging unit 52i judges whether the press amount of the operation unit 10, that is, the sinking amount of the operation unit 10, has reached a value determined in advance when the contact position of the touch sensor 112 is determined by the icon contact judging unit 52d to be in the display region of any icon I. For example, when it is determined by the decision circuit 63 that the first point of contact 62a and the second point of contact 62b are in contact with each other, the press judging unit 52i judges that the press amount of the operation unit 10 has reached the value determined in advance.

When it is determined by the press judging unit 52i that the press amount of the operation unit 10 has reached the value determined in advance, the activation instructing unit 52e instructs the motor driving unit 52h to activate the eccentric motor 40. That is, the activation instructing unit 52e according to the present embodiment instructs the motor driving unit 52h to activate the eccentric motor 40 when it is determined by the icon contact judging unit 52d that the contact position is in the display region of any icon I and when it is determined by the press judging unit 52i that the press amount of the operation unit 10 has reached the value determined in advance.

(Process Flow by the Processor 52)

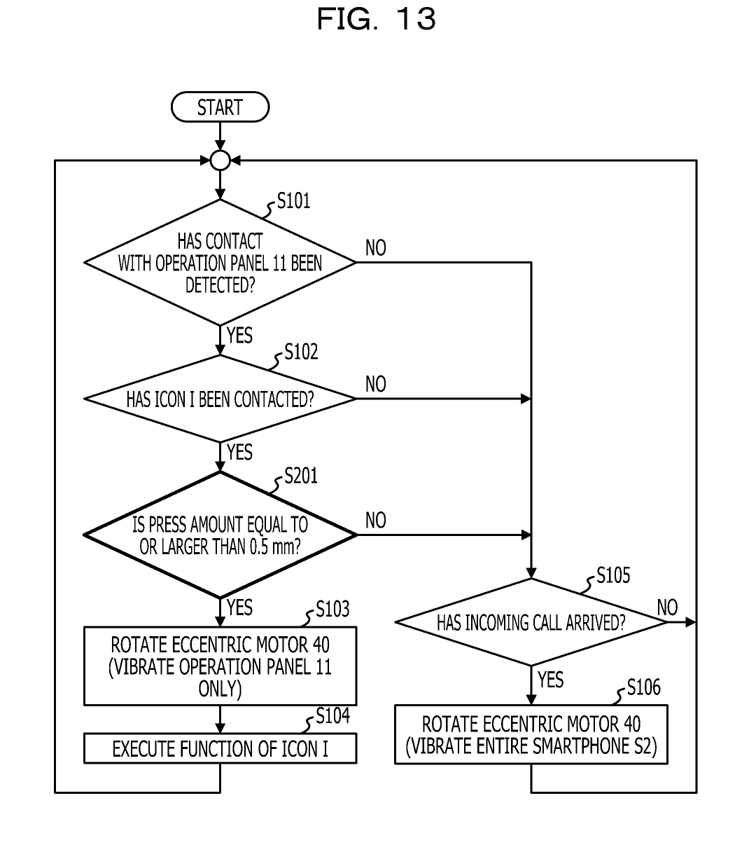

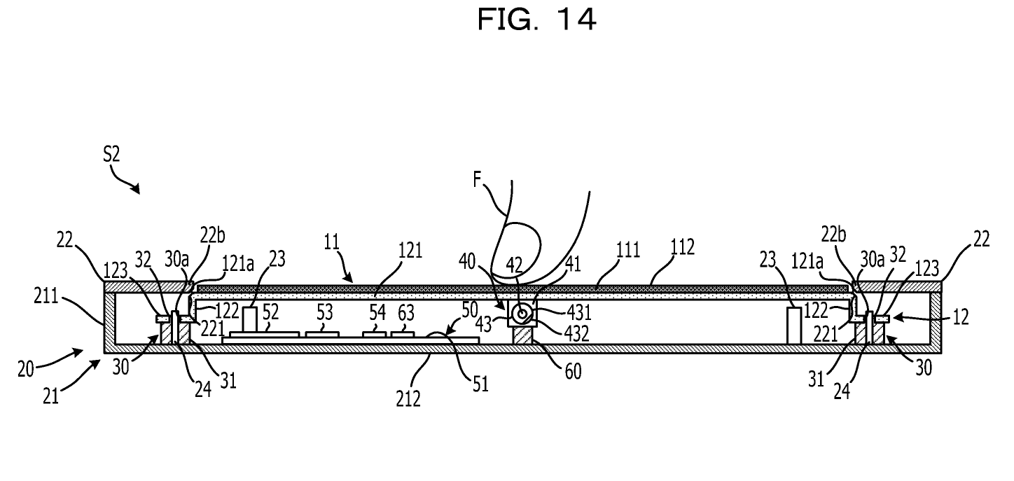

FIG. 13 is a flowchart of a process by the processor 52 according to the second embodiment. FIG. 14 is a schematic view of the smartphone S2 when the fingertip F is in contact with the operation panel 11 according to the second embodiment.

As depicted in FIG. 13, when it is determined by the icon contact judging unit 52d that the contact position of the touch sensor 112 is in the display region of any icon I (Yes at step S102), the press judging unit 52i judges based on the energization information from the decision circuit 63 whether the first point of contact 62a and the second point of contact 62b are in contact with each other. Note that a distance between the first point of contact 62a and the second point of contact 62b when the operation panel 11 is placed at the reference position is set at approximately 0.5 mm. Therefore, by judging whether the first point of contact 62a and the second point of contact 62b are in contact with each other, the press judging unit 52i determines whether the press amount of the operation panel 11 is equal to or larger than 0.5 mm (step S201).

When it is judged that the press amount of the operation panel 11 is equal to or larger than 0.5 mm (Yes at step S201), the activation instructing unit 52e instructs the motor driving unit 52h to activate the eccentric motor 40. Based on the instruction from the activation instructing unit 52e, the motor driving unit 52h activates the eccentric motor 40 to rotate the motor shaft 42 of the eccentric motor 40 (step S103).

On the other hand, when it is not judged that the press amount of the operation panel 11 is equal to or larger than 0.5 mm (No at step S201), the incoming-call checking unit 52g judges whether an incoming call has arrived at the smartphone S2 (step S105).

In the smartphone S2 as described above, when the fingertip F is contact with the operation panel 11, as depicted in FIG. 14, the operation panel 11 comes closer to the bottom plate 212 of the box body 21 to bring the first point of contact 62a of the cushioning member 60 and the second point of contact 62b of the eccentric motor 40 into contact with each other. With this, it is judged that the operation panel 11 has been pressed by the press amount determined in advance, and the eccentric motor 40 is activated.

Here, with the operation panel 11 being pressed, a clearance is formed between the vibration transmitting part 221 of the cover 22 and the vibration transmitting part 121a of the operation unit 10. Thus, vibrations of the operation panel 11 due to the activation of the eccentric motor 40 are not transmitted to the box 20. Furthermore, since the operation panel 11 is supported by the cushioning member 30, the vibrations of the operation panel 11 are not transmitted from the cushioning member 30 to the box 20, either. Therefore, when the user operates the operation panel 11, only the operation panel 11 vibrates, and the vibrations are not transmitted to the palm holding the box 20.

According to the present embodiment, when the press amount of the operation panel 11 has reached the predetermined amount, the eccentric motor 40 is activated. Thus, the operation unit 10 vibrates after a clearance occurs between the vibration transmitting part 121a of the operation unit 10 and the vibration transmitting part 221 of the cover 22. With this, it is possible to reliably suppress vibrations being transmitted to the palm holding the box 20 when the user operates the operation panel 11.

Furthermore, according to the present embodiment, the first point of contact 62a of the mechanical switch 62 of the press sensor 61 is placed on the cushioning member 60. Thus, even if the first point of contact 62a and the second point of contact 62b are brought into contact with each other, vibrations of the eccentric motor 40 are absorbed in the cushioning member 60, and therefore are not transmitted to the box 20. Also from this, it is possible to suppress vibrations being transmitted to the palm holding the box 20.

### Third Embodiment

With reference to FIG. 15 and FIG. 16, a third embodiment is described below. Note that structures and processes equivalent to those in the second embodiment are not described herein.

FIG. 15 is a sectional view of a smartphone S3 according to the third embodiment. FIG. 16 is a schematic view of the smartphone S3 when the fingertip is in contact with an operation panel 11 according to the third embodiment.

As depicted in FIG. 15, an operation unit 70 according to the present embodiment does not include the support plate 122 according to the second embodiment. Therefore, the mount pieces 123 are directly coupled to the side surface of the mount plate 121. Furthermore, the mount pieces 123 are away from the back surface of the cover 22, and a cushioning member 72 is placed in a clearance between the cover 22 and each mount piece 123. The type of the cushioning member 72 is not particularly restrictive and, for example, the cushioning member 30 according to the first and second embodiments may be used. The cushioning member 72 is fixed to both of the cover 22 and the mount piece 123. The cushioning member 72 may be fixed by, for example, being adhered with an adhesive. In a natural state (in a state where no tensile or compressive force is exerted), the cushioning member 72 has a height lower than the clearance between the cover 22 and the mount piece 123 when the operation unit 10 is placed at the reference position. Thus, when the operation unit 10 is placed at the reference position, the cushioning member 72 is pulled from both of the cover 22 and the mount piece 123. Therefore, the operation unit 10 is pressed onto a cover 22 side by the resilience of the cushioning member 72, and is placed at the reference position.

In the smartphone S3 as described above, when the fingertip F is in contact with the operation panel 11, as depicted in FIG. 16, the cushioning member 72 is expanded by the pressure of the fingertip F to bring the operation panel 11 closer to the bottom plate 212 of the box body 21. With this, a clearance is formed between the vibration transmitting part 221 of the cover 22 and the vibration transmitting part 121a of the operation unit 10, and therefore vibrations of the operation panel 11 due to the activation of the eccentric motor 40 are not transmitted to the box 20. Furthermore, since the operation panel 11 is supported by the cushioning member 30, the vibrations of the operation panel 11 are not transmitted from the cushioning member 30 to the box 20, either. Therefore, when the user operates the operation panel 11, only the operation panel 11 vibrates, and the vibrations are not transmitted to the palm holding the box 20.

According to the present embodiment, the cushioning member 72 for supporting the operation unit 10 is fixed not to the bottom plate 212 of the box body 21 but to the cover 22. Thus, the cushioning member 30 is not placed between the bottom plate 212 of the box body 21 and the mount piece 123 of the operation unit 10. With this, a space between the operation unit 10 and the bottom plate 212 of the box body 21 may be effectively used. Furthermore, with the operation unit 10 being mounted on the cover 22 before the cover 22 is mounted on the box body 21, the smartphone S3 may be easily assembled.

### Fourth Embodiment

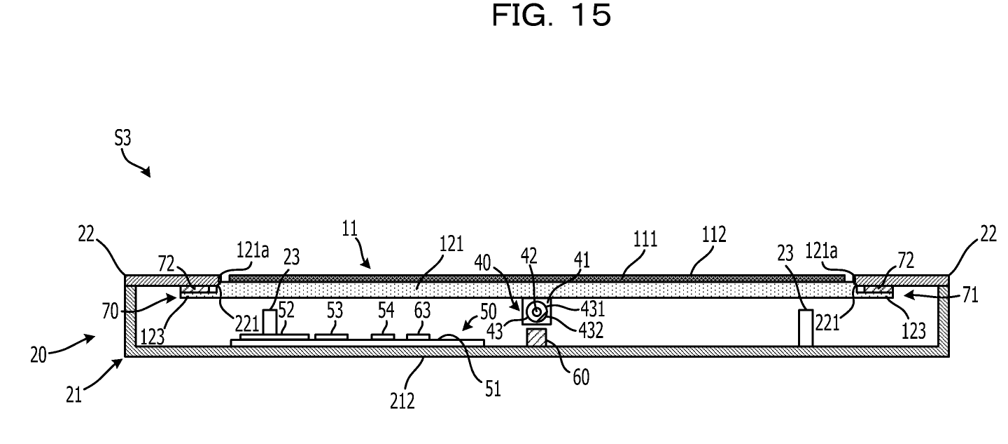

With reference to FIG. 17 to FIG. 19, a fourth embodiment is described below. Note that structures and processes equivalent to those in the third embodiment are not described herein.

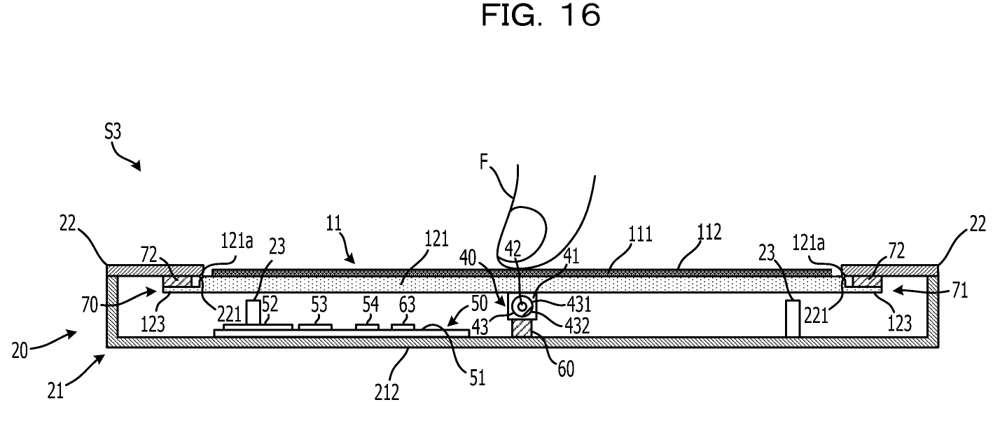

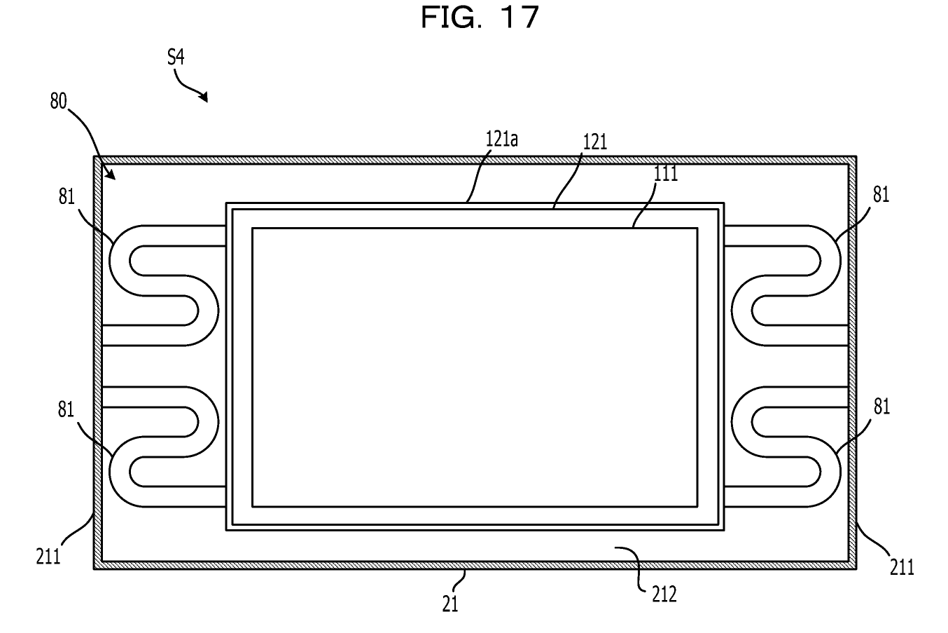

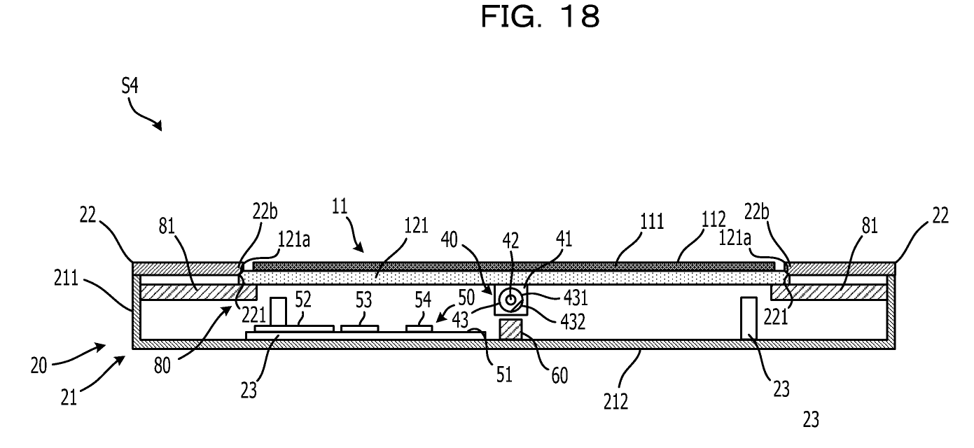

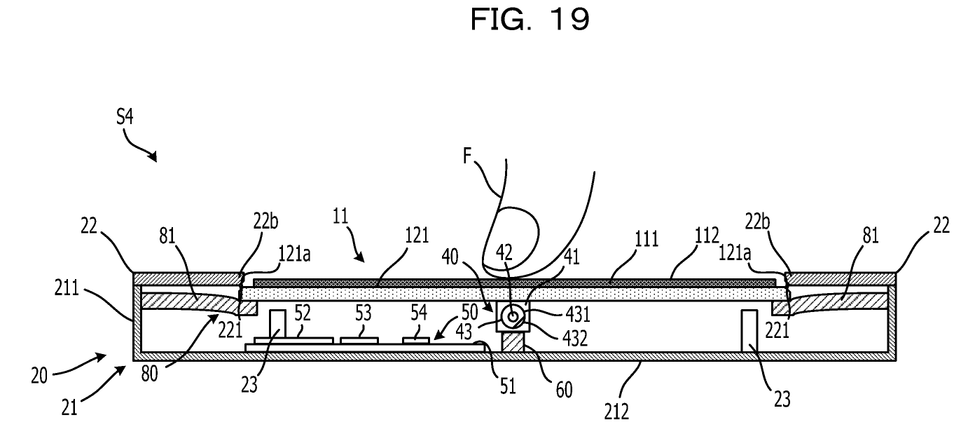

FIG. 17 is a plan view of a smartphone S4 with the cover 22 being removed therefrom according to the fourth embodiment. FIG. 18 is a sectional view of the smartphone S4 according to the fourth embodiment. FIG. 19 is a schematic diagram of the smartphone S4 when the fingertip F is in contact with the operation panel 11 according to the fourth embodiment.

As depicted in FIG. 17 and FIG. 18, an operation unit 80 according to the present embodiment does not include the mount pieces 123 according to the third embodiment. Therefore, cushioning members 81 according to the present embodiment are coupled from the mount plate 121 of the operation unit 10 to the frame plate 211 of the box body 21. The cushioning members 81 are coupled to each short side of the mount plate 121, and extend from the mount plate 121 of the operation unit 10 to the frame plate 211 of the box body 21 in a meandering manner. The number of cushioning members 81 is not particularly restrictive. In the present embodiment, two cushioning members 81 are placed for each short side of the mount plate 121.

In the smartphone S4 described above, when the fingertip F is in contact with the operation panel 11, as depicted in FIG. 19, the cushioning members 81 are warped by the pressure of the fingertip F to cause the operation panel 11 to come closer to the bottom plate 212 of the box body 21. With this, a clearance is formed between the vibration transmitting part 121a of the operation panel 11 and the vibration transmitting part 221 of the cover 22, and therefore vibrations of the operation panel 11 due to the activation of the eccentric motor 40 are not transmitted to the box 20. Furthermore, since the operation panel 11 is supported by the cushioning members 81, the vibrations of the operation panel 11 are not transmitted from the cushioning members 81 to the box 20, either. Therefore, when the user operates the operation panel 11, only the operation panel 11 vibrates, and the vibrations are not transmitted to the palm holding the box 20.

Note that while the cushioning members 81 are placed in a meandering manner in a plane in parallel with the mount plate 121 of the operation panel 11 in the present embodiment, the present embodiment is not restricted to this and may take various forms.

[Experiment Results]

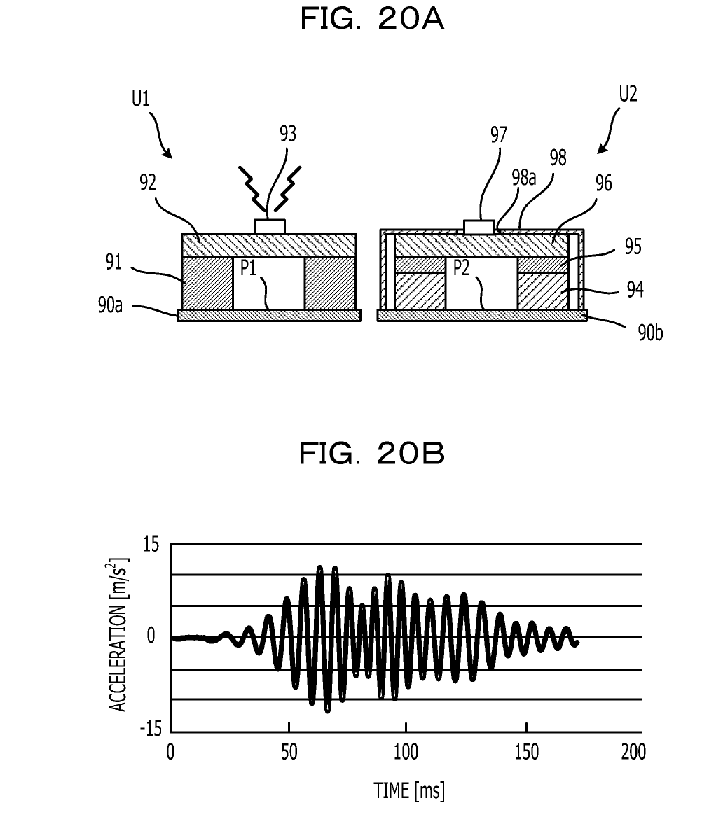

With reference to FIGS. 20A, 20B, 21A, 21B, 22A, and 22B, experiment results of transmission of vibrations of the operation panel 11 according to the first to fourth embodiments, specifically, first to third experiment results, are described below. Note that it is assumed in the following description that the smartphones S1 to S4 according to the first to fourth embodiments are not used as they are but experiment models obtained by simplifying these smartphones for experiments are used.

As experiment models, it is assumed that the first unit U1 and the second U2 are used.

The first unit U1 includes a support unit 91 fixed to a base unit 90a, a plate unit 92 mounted on the support unit 91, and an eccentric motor 93 mounted on the plate unit 92. As the material of the base unit 91a, polycarbonate is used. The base unit 90a is assumed to have a thickness of approximately 2.0 mm. As the material of the support unit 91, the same material as that of the base unit 90a, that is, polycarbonate, is used. As the material of the plate unit 92, SUS304 is used. The plate unit 92 has a thickness of approximately 1.0 mm. As the eccentric motor 93, the one equivalent to the eccentric motor 40 according to the first to fourth embodiments is used.

The second unit U2 includes a support unit 94 fixed to a base unit 90b, a cushioning member 95 mounted on the support unit 94, a plate unit 96 mounted on the cushioning member 95, an eccentric motor 97 mounted on the plate unit 96, and a cover unit 98 that covers the plate unit 96. As the material of the base unit 90b, polycarbonate is used. The base unit 90b is assumed to have a thickness of approximately 2.0 mm.

The support unit 94 of the second unit U2 is configured to have a height lower than that of the support unit 91 of the first unit U1. However, with the cushioning member 95 mounted on the support unit 94, both of the plate units 92 and 96 are set to have the same height. The material of the cushioning member 95 is the same material as that of the cushioning member 30 according to the first to fourth embodiments, that is, a super gel (model name: HC04N) from COSMO INSTRUMENTS CO., LTD. is used. In more detail, the cushioning member 95 is set to have a thickness of 5 mm, a hardness of 4, and a coefficient of extension of 1300%. The plate unit 96 is in contact with the inner surface of the cover unit 98. As the eccentric motor 97, the one equivalent to the eccentric motor 40 according to the first to fourth embodiments is used. The cover unit 98 includes an opening 98a at a position corresponding to the eccentric motor 97, and the eccentric motor 97 protrudes from the opening 98a. Therefore, when the plate unit 96 of the second unit U2 is pressed down, the cushioning member 95 is compressed to cause a clearance between the plate unit 96 and the cover unit 98. This recreates the situation in a simplified manner in which a clearance occurs between the vibration transmitting part 121a of the operation unit 10 and the vibration transmitting part 221 of the cover 22 according to the first to fourth embodiments.

(First Experiment Results)

FIG. 20A and FIG. 20B are schematic diagrams for describing first experiment results of transmission of vibrations by experiment model. FIG. 20A depicts the state of the experiment model, and FIG. 20B depicts acceleration at a position P1 set in the first unit U1.

In the first experiment results, the eccentric motor 93 of the first unit U1 is activated.

As depicted in FIG. 20A, when the eccentric motor 93 of the first unit U1 is activated, it may be found as depicted in FIG. 20B that the acceleration of the base unit 90 has locally reached approximately 11.2 m/s² at the position P1 set in the first unit U1.

(Second Experiment Results)

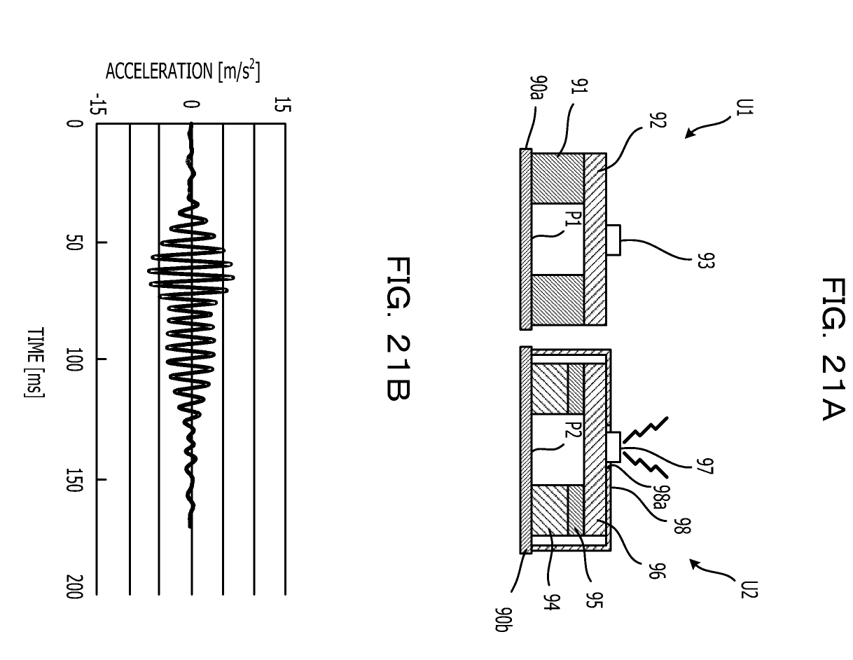

FIG. 21A and FIG. 21B are schematic diagrams for describing second experiment results of transmission of vibrations by experiment model. FIG. 21A depicts the state of the experiment model, and FIG. 21B depicts acceleration at a position P2 set in the second unit U2.

In the second experiment results, the eccentric motor 97 of the second unit U2 is activated.

As depicted in FIG. 21A, when the eccentric motor 97 of the second unit U2 is activated, it may be found as depicted in FIG. 21B that the acceleration of the base unit 90 has locally reached approximately 6.7 m/s² at the position P2 set in the second unit U2. When the plate unit 96 and the inner surface of the cover unit 98 are in contact with each other, vibrations of the eccentric motor 97 may be transmitted to the base unit 90, while the acceleration is approximately half of that of the first experiment results.

(Third Experiment Results)

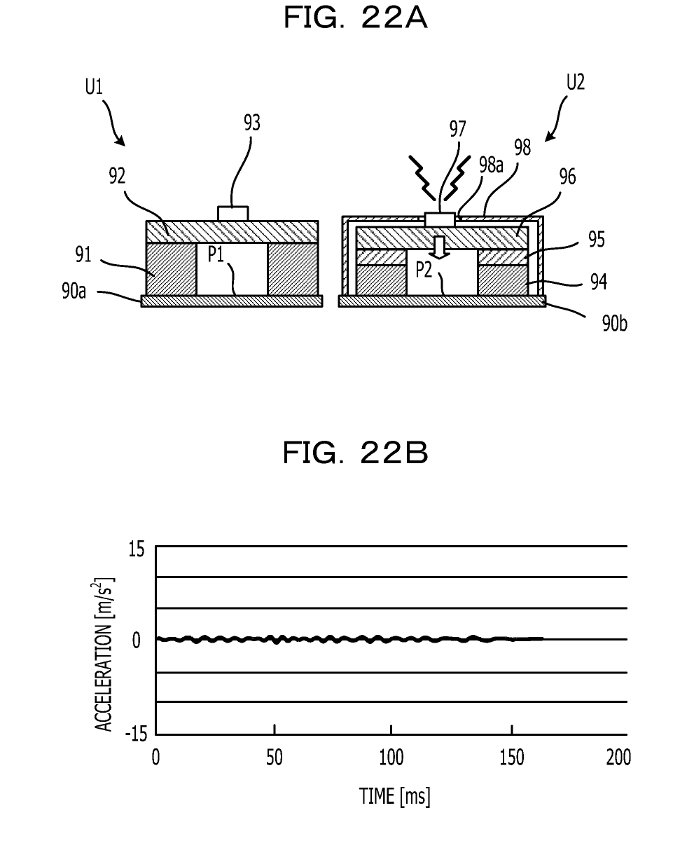

FIG. 22A and FIG. 22B are schematic diagrams for describing third experiment results of transmission of vibrations by experiment model. FIG. 22A depicts the state of the experiment model, and FIG. 22B depicts acceleration at the position P2 set in the second unit U2.

In the third experiment results, the eccentric motor 97 is activated while the plate unit 96 of the second unit U2 is being pressed down to cause the plate unit 96 to be away from the cover unit 98.

As depicted in FIG. 22A, when the eccentric motor 97 of the second unit U2 is activated while the plate unit 96 of the second unit U2 is being pressed down to form a clearance between the plate unit 96 and the cover unit 98, it may be found as depicted in FIG. 22B that the acceleration of the base unit 90 has being locally suppressed to approximately 0.35 m/s² at the position P2 set in the second unit U2. Compared with the second experiment results, it may be found that the acceleration of the vibrations is reduced to approximately one twentieth and, with a clearance being formed between the cover unit 98 and the plate unit 96, the vibrations of the eccentric motor 97 are not transmitted to the base unit 90.

From the above, it has been confirmed that if a clearance is formed between the vibration transmitting part 121a of the operation unit 10 and the vibration transmitting part 221 of the cover 22 according to the first to fourth embodiments, the vibrations of the operation panel 11 are not transmitted to the box 20 and the palm holding any of the smartphones S1 to S4 does not feel strange.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A portable terminal device comprising:
an operation panel that displays an input region and detects a contact position;
an actuator fixed to the operation panel to vibrate the operation panel when the contact position detected by the operation panel is included in the input region;
a housing accommodating the operation panel and having an opening through which the operation panel is exposed; and
a member provided in the box to support the operation panel with the operation panel pressed toward the housing so as to bring the operation panel into contact with and away from the housing, the member having a vibration absorbing property higher than a vibration absorbing property of the housing.

2. The portable terminal device according to claim 1, wherein
the actuator vibrates the operation panel when an amount of clearance between the housing and the operation panel reaches a predetermined value.

3. The portable terminal device according to claim 2, further comprising:
a processor that executes a process including
judging whether the contact position detected by the operation panel is included in the input region,
judging whether the amount of clearance between the housing and the operation panel reaches the predetermined value, and
actuating the actuator when the contact position detected by the operation panel is included in the input region and the amount of clearance between the housing and the operation panel reaches the predetermined value.

4. The portable terminal device according to claim 3, wherein
the operation panel includes
a display that displays the input region, and
a touch sensor attached to a surface of the display on a side corresponding to the opening to detect the contact position,
the actuator is fixed to a surface of the display on a side opposite to the touch sensor, and
the judging whether the amount of clearance reaches the predetermined value includes detecting a contact between a first contact member and a second contact member, the first contact member provided at a position of the actuator on a side opposite to the operation panel, the second contact member provided at a position of the housing facing the first contact member

5. The portable terminal device according to claim 4, further comprising:
a member provided to the housing so as to support the second contact member and having a vibration absorbing property higher than a vibration absorbing property of the housing.

6. The portable terminal device according to claim 1, wherein
an edge of the housing that defines the opening includes an inclined surface at a position facing the operation panel, the inclined surface undergoing displacement to a side opposite to the operation panel as coming closer to a center of the opening, and
the member presses the operation panel toward the inclined surface.
